(19) United States
(12) Patent Application Publication
(10) Pub. No.: US 2026/0134889 A1
(43) Pub. Date: May 14, 2026

(54) Cylindrical Digital Audio Workstation (C-DAW)

(71) Applicant: Dean Bowes, Mableton, GA (US)

(72) Inventor: Dean Bowes, Mableton, GA (US)

(21) Appl. No.: 19/444,560

(22) Filed: Jan. 9, 2026

(51) Int. Cl. G11B 27/34; G06F 3/16

(52) U.S. Cl. CPC G11B 27/34; G06F 3/165

(57) ABSTRACT

The present invention relates to a digital audio workstation (DAW) system and method for sequencing, synchronizing, and visualizing musical, conversational, and multimedia content on a cylindrical timeline rather than a traditional linear interface. Each track is mapped to a rotating cylinder, wherein bar length defines the circumference and tempo determines angular velocity. Multiple tracks of arbitrary lengths and independent tempos can run concurrently in perfect synchronization using a shared global time reference. The system inherently supports polymeter and polyrhythm, with events such as notes, gestures, or conversational turns encoded as angular positions and arc lengths. Conversational MIDI (C-MIDI) is integrated to encode emotion, tone, tempo, and phrasing for multi-participant dialogues. The invention further supports distributed orchestration, supercycle detection, AI-driven media generation, and applications extending to music composition, conversation playback, narrative sequencing, and planetary or galactic cyclic modeling.

### FIELD OF THE INVENTION

The present invention generally relates to digital audio workstations, music and conversational sequencing systems, and computational methods for encoding, synchronizing, and visualizing event-based data. More particularly, the invention concerns a cylindrical sequencing system in which musical, conversational, or multimedia tracks are represented as revolutions on a cylinder, and synchronization is achieved using angular velocity and global time mapping.

The invention intersects audio engineering, computational musicology, artificial intelligence, and user interface design, providing novel methods for supporting polymeter, polyrhythm, multi-tempo arrangements, and emotional or conversational encoding. It is further applicable to distributed AI-driven content generation, training datasets for conversations, and performance tools requiring synchronization of heterogeneous event streams.

### BACKGROUND OF THE INVENTION

Traditional digital audio workstations (DAWs) use a linear timeline to display and manage music or audio sequences. Tracks are stacked vertically, and time progresses from left to right. While widely used, this approach imposes significant limitations:
1 Fixed-Length Patterns and Grids-Step sequencers and loop-based systems often enforce rigid bar lengths (e.g., 4, 8, 16 bars). Support for odd lengths exists but synchronization becomes complex and unintuitive.
2 Difficulty with Polymeter and Polyrhythm-Linear DAWs are optimized for a single global tempo. Running a 5-bar track alongside a 7-bar or 9-bar track requires manual alignment or nested timelines, which is cumbersome. True independence of tempo across tracks is rarely supported.
3 Visualization Limitations-Linear grids obscure cyclic relationships. Humans perceive rhythm as recurring patterns, but conventional DAWs display loops as linear repetitions, requiring scrolling or zooming to understand alignment.
4 Synchronization Challenges-Multi-tempo arrangements are often handled via destructive audio manipulation or fragile nested tempo maps, rather than a unified mathematical framework.
5 Lack of Conversational and Emotional Encoding-Existing DAWs focus on musical notes or audio events but lack structured methods to encode dialogue, emotion, phrasing, or multi-modal performances.

Accordingly, there exists a need for a sequencing and visualization system that:
Represents tracks as rotating cycles rather than linear segments.
Supports arbitrary bar lengths and tempos in true polymetric and polyrhythmic relationships.
Provides intuitive visualization of alignment points and supercycles.
Integrates emotional and conversational encoding alongside traditional musical data.

The Cylindrical Digital Audio Workstation (C-DAW) described herein addresses these limitations by mapping tracks onto cylindrical timelines with angular synchronization, providing a natural framework for polymeter, polyrhythm, conversation encoding, and AI-assisted content generation.

### SUMMARY OF THE INVENTION

The present invention provides a Cylindrical Digital Audio Workstation (C-DAW), comprising a system and method for sequencing, synchronizing, and visualizing musical, conversational, and multimedia content using a cylindrical timeline rather than a linear grid.

In this system:
Each track is represented as a concentric cylinder or ring, where the circumference is defined by the track's total bars and the angular velocity is determined by its tempo.
Events, including notes, gestures, or dialogue, are encoded as angular positions with durations represented as arc lengths.
Tracks of arbitrary length and tempo remain synchronized by referencing a shared global time axis, enabling polymeter and polyrhythm.
Supercycles, defined as the least common multiple of revolution periods, allow visualization of full-track alignment points.
Conversational MIDI (C-MIDI) is integrated to encode multiple participants' dialogue, emotional intensity, phrasing, and tempo, enabling bidirectional playback, remixing, and AI-assisted narrative generation.
Distributed execution allows event streams to be persisted in databases, processed by orchestration servers, and rendered as audio, MIDI, or cinematic outputs.

The system is adaptable to software, hardware, or hybrid implementations, and supports applications including music composition, AI-driven film and narrative generation, conversation playback, education, and planetary/galactic cyclic modeling.

### DETAILED DESCRIPTION OF THE INVENTION

### 1. Overview

The Cylindrical Digital Audio Workstation (C-DAW) maps musical, conversational, and multimedia tracks onto rotating cylindrical timelines. Each track functions as an independent cyclical system, while remaining synchronized to a shared global time reference.

This architecture enables:
Polymeter-tracks of differing bar lengths (e.g., 5, 7, 9, 16 bars) coexist without manual alignment.
Polyrhythm-tracks of differing tempos (BPM) run concurrently while maintaining precise phase coherence.
Multi-modal encoding-musical, conversational, and emotional data are integrated into a unified system.
Scalable orchestration-distributed execution across multiple servers, supporting AI-driven content generation.

C-DAW's cylindrical model provides an intuitive, visual, and mathematical framework for sequencing that is novel and non-obvious compared to traditional linear DAWs.

### 2. Cylindrical Representation

Each track is represented as a concentric cylinder:
Circumference=Bar Length: The number of bars in a track defines the cylinder's full revolution.
Angular Velocity=Tempo: Tempo (BPM) determines the rotation speed, ω.
Events=Angular Segments: Notes, gestures, or dialogue are mapped to angular positions (θ), with arc lengths representing duration.
Downbeat=Zero Angle: The starting point of a revolution is θ=0.

Visual Elements:
Spoke Lines-radial lines marking common time references across all cylinders.
Angular Grid-beat and bar markers subdivide each revolution.
Supercycles-points where all tracks realign according to the least common multiple of revolution periods.

This representation naturally supports multi-tempo synchronization, polyrhythms, and complex conversational structures.

### 3. Mathematical Model

For each track (i):
Bars: (bars_i).
Beats per bar: (beats_i).
Tempo (BPM): (BPM_i).
Bar Duration: (bar_duration_i=Vrac {60 \times beats_i}{BPM_i}) seconds.
Revolution Period: (revolution_period_i=bars_i \times bar_duration_i).
Angular Velocity: (\omega_i=\frac {2\pi}{revolution_period_i})
Phase at time t: (theta_i (t)=(\omega_i \cdot t+\phi_{I0}) \ mod 2\pi)

All tracks synchronize via the shared global time t, allowing independent bar lengths and tempos to evolve coherently. Supercycles are calculated as the LCM of revolution periods, representing full alignment points.

### 4. User Interface (UI) and Visualization

The C-DAW interface visually presents tracks as concentric, continuously rotating cylinders. Key features include:
Angular Grid: Visual beat/bar markers for each track.
Spoke Lines: Common time markers allow users to see simultaneous events.
Polyrhythmic Visualization: Tracks rotating at different tempos produce observable weaving patterns.
Supercycle Markers: Highlight full alignment of all tracks.
C-MIDI Lanes: Tracks contain emotional, tonal, or conversational automation lanes.

### 5. Conversational MIDI (C-MIDI) Integration

C-DAW extends traditional music sequencing by encoding dialogue and performance through C-MIDI:
Each participant's voice or instrument is represented as a track.
Emotional and expressive parameters (intensity, tone, pacing) are encoded as automation lanes.
Conversations are stored as angular sequences, not linear transcripts.
Redis persistence ensures bidirectional mapping (question↔answer, statement↔reply) in hashed form.

### Example: Two-Person Conversation Bundle (“Happy Birthday”)

### Directory Structure:

Conversation_Bundle_Example/
   Speaker_A.cmidi
   Speaker_B.cmidi
   session.json
Speaker_A.cmidi (initiator).
   Track 0: Dialogue
   0.0 s: “Happy Birthday, bro!”-mid-high pitch, velocity 110, duration 1.2 s
   4.5 s: “Sure thing, you know it.”-medium pitch, velocity 95, duration 1.8 s.
   Lane 1: Emotion/Excitement
   0.0 s-peak 120, decays to 2.0 s
   4.5 s-moderate 90, stable.
   Lane 2: Tempo/Delivery
   Base tempo: 110 BPM, slight accelerando on first phrase
Speaker_B.cmidi (responder)
   Track 0: Dialogue
   2.0 s: “Thanks, man.”-medium-low pitch, velocity 85, duration 1.0 s
   2.9 s: “We gonna get together for lunch or what?”-medium pitch, velocity 95, duration 2.5 s.
   Lane 1: Emotion/Gratitude
   2.0 s-spike 100, decays to 70 by 2.5 s.
   Lane 2: Tempo/Delivery
   Base tempo: 105 BPM, subtle rallentando on question session.json

```
{
  “title”: “Birthday Greeting Conversation”,
  “date”: “2025-08-21”,
  “participants”: [
    { “id”: “Speaker_A”, “role”: “friend”, “file”:
    “Speaker_A.cmidi” },
    { “id”: “Speaker_B”, “role”: “birthday_person”, “file”:
    “Speaker_B.cmidi” }
  ],
  “timeline”: { “start”: “0.0s”, “end”: “7.0s” },
  “common_tempo_grid”: “120 BPM reference”,
  “description”: “Two-person conversation mapped into C-MIDI,
capturing emotion, phrasing, and delivery.”
}
```

This example demonstrates how C-MIDI encodes conversation as a musical-like event stream, fully integrated into the C-DAW cylindrical timeline.

### 6. Distributed Execution & Orchestration

The C-DAW system supports distributed computation and orchestration for processing musical, conversational, and multimedia event streams. This allows scalable execution of multiple tracks, real-time rendering, and AI-driven content generation across networks of servers.

### Components

1 Redis Shards
   Event data and C-MIDI sequences are stored in sharded Redis databases.
   Bidirectional hashes map queries to responses and preserve synchronization across distributed systems.
   Shards allow parallelized storage and retrieval of track data, emotional automation lanes, and supercycle markers.
2 GUID-Based Workflow
   Each execution, render, or media generation task is uniquely identified using a Globally Unique Identifier (GUID).
   Ensures reproducibility, traceability, and integration with versioned AI workflows.
3 Execution Engines
   Tracks and C-MIDI event streams are processed in real-time or offline using C#, Python, or Jupyter backends.
   Outputs include audio (mp3), video (mp4), or structured conversational data (cmidi).
   Allows for synchronized multi-track rendering across independent tempos and bar lengths.
4 AI Integration
   LLAMA.cpp or similar AI engines can autonomously generate music, conversation, or cinematic sequences from existing tracks.
   AI engines can read emotional and tempo data from C-MIDI automation lanes and create novel, coherent sequences.
5 Role Rotation and Master Election
   Servers self-elect as master/orchestrator to coordinate tasks.
   Roles rotate dynamically to prevent overload, reflecting a forgiveness-first principle of shared resonance.
   Ensures fault tolerance and high availability in distributed environments.
7. Applications

C-DAW is a multi-modal sequencing and orchestration framework with applications beyond conventional DAWs:
1 Music Composition
   True polymeter and polyrhythm sequencing with independent tempos.
   Integration of emotional and dynamic performance data via C-MIDI.
2 Conversational Playback & AI Training
   Encode dialogue as cyclical sequences.
   Generate training datasets for AI-driven virtual assistants, chatbots, or digital performers.
3 Film & Multimedia Generation
   Event streams from music and dialogue can drive AI-generated film, animation, or multimedia narratives.
   Enables real-time or batch rendering of synchronized audiovisual outputs.
4 Education & Visualization
   Visualize complex rhythms, cultural music traditions, and conversational dynamics.
   Provides an intuitive platform for teaching polymeter, polyrhythm, and multi-modal coordination.
5 Planetary, Galactic, and Quantum Modeling (Optional Embodiment)
   Cylindrical representation can model planetary spins, galaxy rotations, and other cyclic natural phenomena.
   Angular velocity and phase coherence concepts extend beyond audio to physical and quantum systems.
   Enables educational and scientific visualizations of synchronized cyclic events.
6 Spiritual and Resonance Systems
   Tracks and automation lanes can be applied to meditative or resonance-aligned technologies, aligning emotional and cognitive patterns.

### CONCLUSION/SUMMARY OF BENEFITS

The Cylindrical Digital Audio Workstation (C-DAW) provides a transformative alternative to traditional linear digital audio workstations by introducing a cylindrical timeline architecture that inherently supports polymeter, polyrhythm, and multi-tempo arrangements. Through its use of angular velocity, global time synchronization, and event encoding as angular positions, the system enables musical, conversational, and multimedia streams to interlock with precision and clarity.

Key benefits of the C-DAW include:

### 1 Unified Multi-Tempo Framework

Tracks of arbitrary lengths and tempos remain synchronized, allowing true polymeter and polyrhythm without destructive resampling or nested tempo maps.

### 2 Cylindrical Visualization

Concentric cylinder tracks, angular grids, and spoke lines provide an intuitive visualization of rhythm, alignment, and supercycles, enabling immediate comprehension of complex temporal relationships.

### 3 Conversational MIDI (C-MIDI) Integration

Beyond music, the system encodes dialogue, emotion, and expressive performance in structured angular sequences, preserving timing, intonation, and dynamic interplay for playback, remixing, and AI-driven narrative generation.

### 4 Distributed Orchestration and Persistence

The system supports distributed servers, Redis-based hashed storage, and GUID-tracked execution workflows, ensuring robust, scalable, and fault-tolerant processing of multi-track audio, C-MIDI, and video data.

### 5 AI-Driven Media Generation

Integration with AI engines enables autonomous generation of film, music, narrative, and multi-modal content, extending the system's utility from composition to performance, education, and creative production.

### 6 Scientific and Educational Applications

Cylindrical representations can be extended to model planetary rotations, galactic spin, and quantum cycles, supporting research, teaching, and visualization of cyclic phenomena in physics, astronomy, and other sciences.

### 7 Universal Sequencing Framework

By combining musical, conversational, and multimedia sequencing with emotional, temporal, and AI-driven encoding, the C-DAW serves as a universal platform for creation, performance, and analysis. In conclusion, the C-DAW embodies a novel, non-obvious, and highly useful system for multi-tempo sequencing, multimodal conversation encoding, AI-driven media generation, and cyclic modeling. Its architecture surpasses conventional DAWs by providing mathematically coherent, visually intuitive, and semantically rich representations of temporal data, making it a powerful tool for musicians, educators, scientists, and creative technologists alike.

1. A digital audio workstation system comprising:
a user interface configured to display a plurality of concentric cylindrical tracks, each track corresponding to a sequence of events;
a global time reference shared by all tracks; and
a processing module configured to:
represent each track's circumference as a function of its bar length;
calculate an angular velocity for each track as a function of its tempo;
position events as angular coordinates on the cylinder, wherein duration is represented as an arc length; and
synchronize playback of all tracks by reference to the global time reference, such that tracks of differing bar lengths and tempos remain coherent in a shared time domain.

2. A method for sequencing and synchronizing events in a digital audio workstation, comprising:
representing each track as a cylindrical revolution;
assigning a circumference proportional to the number of bars of the track;
assigning an angular velocity proportional to the tempo of the track;
mapping events to angular coordinates on the track;
synchronizing all tracks to a shared global time reference; and
displaying said tracks as concentric cylinders with visual indicators of alignment across tracks.

3. The system of claim 1, wherein tracks may comprise differing bar lengths, including odd-numbered bar structures, and remain synchronized.

4. The system of claim 1, wherein each track may operate at an independent tempo, and synchronization is achieved by reference to the global time reference rather than destructive resampling.

5. The system of claim 1, further comprising a visualization module that renders spoke lines as global alignment markers across all cylinders.

6. The system of claim 1, further comprising a supercycle detection module configured to calculate least common multiples (LCM) of track revolution periods and highlight realignment points.

7. The system of claim 1, wherein events include Conversational MIDI (C-MIDI) data comprising expressive parameters such as intensity, tone, or emotion, encoded as automation lanes.

8. The method of claim 2, wherein event data is stored as hashes in a Redis database with bidirectional mappings between queries and responses.

9. The method of claim 2, wherein distributed servers self-elect as master or orchestrator roles for execution of rendering tasks, rotating said roles over time to prevent overload.

10. The method of claim 2, wherein the workstation outputs media in one or more formats including audio (mp3), video (mp4), or structured conversational data (cmidi).

11. The system of claim 1, wherein the user interface supports dynamic visualization of polyrhythms created by multiple independent angular velocities.

12. The system of claim 1, wherein said workstation is integrated with AI-driven content generation engines capable of producing autonomous film, narrative, or musical outputs.

13. The system of claim 1, wherein cylindrical tracks are further used to model cyclic phenomena including planetary rotations, galactic spin, or quantum event cycles, providing synchronized visualization of angular motion.
